(19) United States
(12) Patent Application Publication
(10) Pub. No.: US 2011/0027584 A1
(43) Pub. Date: Feb. 3, 2011

(54) Silicone Composition, Silicone Adhesive, Coated and Laminated Substrates

(76) Inventors: Bianxiao Zhong, Midland, MI (US); Bizhong Zhu, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 12/918,353

(22) PCT Filed: Feb. 23, 2009
(86) PCT No.: PCT/US2009/034841

§ 371 Date: Sep. 22, 2010

Related U.S. Application Data
(60) Provisional application No. 61/033,446, filed on Mar. 4, 2008.

(51) Int. Cl. B32B 17/10; C08L 83/05; C09J 183/05; B32B 7/12

(52) U.S. Cl. 428/355 R; 525/477; 525/479; 525/474; 528/31; 428/446; 428/429

(57) ABSTRACT

A silicone composition comprising at least one organohydrogenpolysiloxane having an average of at least two silicon-bonded hydrogen atoms per molecule, a cross-linking agent having an average of at least two aliphatic carbon-carbon double bonds per molecule, and a hydrosilylation catalyst; a silicone adhesive comprising a cured product of at least one oganohydrogenpolysiloxane; and a coated substrate and a laminated substrate, each comprising the silicone adhesive.

### CROSS-REFERENCE TO RELATED APPLICATIONS

This application claims the benefit of U.S. Provisional Patent Application Ser. No. 61/033447, filed on 4 Mar. 2008, under 35 U.S.C. §119(e). U.S. Provisional Patent Application Ser. No. 61/033447 is hereby incorporated by reference.

### FIELD OF THE INVENTION

The present invention relates to a silicone composition and more particularly to a silicone composition comprising at least one organohydrogenpolysiloxane having an average of at least two silicon-bonded hydrogen atoms per molecule, a cross-linking agent having an average of at least two aliphatic carbon-carbon double bonds per molecule, and a hydrosilylation catalyst. The present invention also relates to a silicone adhesive comprising a cured product of at least one organohydrogenpolysiloxane. The present invention further relates to a coated substrate and to a laminated substrate, each comprising the silicone adhesive.

### BACKGROUND OF THE INVENTION

Silicone adhesives are useful in a variety of applications by virtue of their unique combination of properties, including high thermal stability, good moisture resistance, excellent flexibility, high ionic purity, low alpha particle emissions, and good adhesion to various substrates. For example, silicone adhesives are widely used in the automotive, electronic, construction, appliance, and aerospace industries.

However, when conventional silicone adhesives are exposed to high temperatures, for example temperatures encountered by direct contact with an open flame, the adhesives decompose to form a char, typically a nonadherent powder.

In view of the foregoing, there is a need for a silicone composition that cures to form an adhesive having high char yield, and high adhesion during and after exposure to temperatures above the decomposition temperature of the adhesive.

### SUMMARY OF THE INVENTION

The present invention is directed to a silicone composition, comprising:
(A) at least one organohydrogenpolysiloxane having the formula (R¹₂R²SiO_{1/2})ₘ (R¹R²SiO_{2/2})ₙ(R¹SiO_{3/2})ₚ (I), wherein each R¹ is independently C₁ to C₁₀ hydrocarbyl or C₁ to C₁₀ halogen-substituted hydrocarbyl, both free of aliphatic unsaturation, each R² is independently R¹ or —H, m is from 0.001 to 0.3, n is from 0.5 to 0.999, p is from 0 to 0.5, and m+n+p=1, provided the organohydrogenpolysiloxane has an average of at least two silicon-bonded hydrogen atoms per molecule;
(B) a cross-linking agent selected from (i) at least one organic compound having an average of at least two aliphatic carbon-carbon double bonds per molecule, (ii) at least one organosilane having an average of at least two silicon-bonded alkenyl groups per molecule, (iii) at least one silicone resin having an average of at least two silicon-bonded alkenyl groups per molecule, (iv) at least on organosiloxane having an average of at least two silicon-bonded alkenyl groups per molecule, and (v) a mixture comprising at least two of (i), (ii), (iii), and (iv); wherein the ratio of the number of moles of aliphatic carbon-carbon double bonds in the cross-linking agent (B) to the number of moles of silicon-bonded hydrogen atoms in the organohydrogenpolysiloxane (A) is from 0.005 to 0.7; and
(C) a hydrosilylation catalyst.

The present invention is also directed to a silicone adhesive comprising a cured product of at least one organohydrogenpolysiloxane having the formula (I) above.

The present invention is further directed to a coated substrate, comprising:
a substrate; and
a silicone adhesive coating on at least a portion of a surface of the substrate, wherein the adhesive coating comprises a cured product of at least one organohydrogenpolysiloxane having the formula (I) above.

The present invention is still further directed to a laminated substrate, comprising:
a first substrate;
at least one additional substrate overlying the first substrate; and
a silicone adhesive coating on at least a portion of at least one surface of each substrate, provided at least a portion of the adhesive coating is between and in direct contact with opposing surfaces of adjacent substrates, wherein the adhesive coating comprises a cured product of at least one organohydrogenpolysiloxane having the formula (I) above.

The silicone adhesive of the present invention has high transparency and excellent adhesion to various substrates. Moreover, the silicone adhesive has high adhesion during and after exposure to temperatures above the decomposition temperature of the adhesive, low flammability (as evidenced by low heat release rate), and high char yield.

The silicone adhesive of the present invention is useful in applications requiring adhesives having high adhesion at elevated temperatures, low flammability, and high transparency. For example, the adhesive is useful for bonding glass panels in the fabrication of fire rated windows and glass firewalls.

These and other features, aspects, and advantages of the present invention will become better understood with reference to the following description, appended claims, and accompanying drawings.

### BRIEF DESCRIPTION OF THE DRAWINGS

FIG. 1 shows a cross-sectional view of one embodiment of a laminated substrate according to the present invention.

FIG. 2 shows a cross-sectional view of the previous embodiment of the laminated substrate, further comprising a second silicone adhesive coating on the second substrate and a third silicone adhesive coating on the second opposing surface of the first substrate.

### DETAILED DESCRIPTION OF THE INVENTION

As used herein, the term “alkenyl group” refers to a monovalent hydrocarbon group containing one aliphatic carbon-carbon double bond.

A silicone composition according to the present invention comprises:
(A) at least one organohydrogenpolysiloxane having the formula (R¹₂R²SiO_{1/2})ₘ (R¹R²SiO_{2/2})ₙ(R¹SiO_{3/2})ₚ (I), wherein each R¹ is independently C₁ to C₁₀ hydrocarbyl or C₁ to C₁₀ halogen-substituted hydrocarbyl, both free of aliphatic unsaturation, each R² is independently R¹ or —H, m is from 0.001 to 0.3, n is from 0.5 to 0.999, p is from 0 to 0.5, and m+n+p=1, provided the organohydrogenpolysiloxane has an average of at least two silicon-bonded hydrogen atoms per molecule;
(B) a cross-linking agent selected from (i) at least one organic compound having an average of at least two aliphatic carbon-carbon double bonds per molecule, (ii) at least one organosilane having an average of at least two silicon-bonded alkenyl groups per molecule, (iii) at least one silicone resin having an average of at least two silicon-bonded alkenyl groups per molecule, (iv) at least on organosiloxane having an average of at least two silicon-bonded alkenyl groups per molecule, and (v) a mixture comprising at least two of (i), (ii), (iii), and (iv); wherein the ratio of the number of moles of aliphatic carbon-carbon double bonds in the cross-linking agent (B) to the number of moles of silicon-bonded hydrogen atoms in the organohydrogenpolysiloxane (A) is from 0.005 to 0.7; and
(C) a hydrosilylation catalyst.

Component (A) is at least one organohydrogenpolysiloxane having the formula (R¹₂R²SiO_{1/2})ₘ(R¹R²SiO_{2/2})ₙ(R¹SiO_{3/2})ₚ (I), wherein each R¹ is independently C₁ to C₁₀ hydrocarbyl or C₁ to C₁₀ halogen-substituted hydrocarbyl, both free of aliphatic unsaturation, each R² is independently R¹ or —H, m is from 0.001 to 0.3, n is from 0.5 to 0.999, p is from 0 to 0.5, and m+n+p=1, provided the organohydrogenpolysiloxane has an average of at least two silicon-bonded hydrogen atoms per molecule.

The organohydrogenpolysiloxane having the formula (I) has a linear or branched structure. The organohydrogenpolysiloxane can be a homopolymer containing identical repeat units or a copolymer containing two or more different repeat units. In a copolymer, the units can be in any order. For example, the organohydrogenpolysiloxane can be a random, alternating, or block copolymer.

The hydrocarbyl and halogen-substituted hydrocarbyl groups represented by R¹ are free of aliphatic unsaturation and typically have from 1 to 10 carbon atoms, alternatively from 1 to 6 carbon atoms. Acyclic hydrocarbyl and halogen-substituted hydrocarbyl groups containing at least 3 carbon atoms can have a branched or unbranched structure. Examples of hydrocarbyl groups represented by R¹ include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl, such as cyclopentyl, cyclohexyl, and methylcyclohexyl; aryl, such as phenyl and naphthyl; alkaryl, such as tolyl and xylyl; and aralkyl, such as benzyl and phenethyl. Examples of halogen-substituted hydrocarbyl groups represented by R¹ include, but are not limited to, 3,3,3-trifluoropropyl, 3-chloropropyl, chlorophenyl, dichlorophenyl, 2,2,2-trifluoroethyl, 2,2,3,3-tetrafluoropropyl, and 2,2,3,3,4,4,5,5-octafluoropentyl.

In the formula (I) of the organohydrogenpolysiloxane, the subscripts m, n, and p are mole fractions. The subscript m typically has a value of from 0.001 to 0.3, alternatively from 0.02 to 0.15, alternatively from 0.02 to 0.05; the subscript n typically has a value of from 0.5 to 0.999, alternatively from 0.6 to 0.9, alternatively from 0.7 to 0.9; and the subscript p typically has a value of from 0 to 0.5, alternatively from 0 to 0.3, alternatively from 0 to 0.15.

Typically at least 50 mol %, alternatively at least 65 mol %, alternatively at least 80 mol % of the groups R² in the organohydrogenpolysiloxane are hydrogen. The term “mol % of the groups R² in the organohydrogenpolysiloxane are hydrogen” is defined as the ratio of the number of moles of silicon-bonded hydrogen atoms in the organohydrogenpolysiloxane to the total number of moles of the groups R² in the organohydrogenpolysiloxane, multiplied by 100.

The organohydrogenpolysiloxane typically has a number-average molecular weight (Mₙ) of from 500 to 50,000, alternatively from 1000 to 20,000, alternatively 2,000 to 10,000, where the molecular weight is determined by gel permeation chromatography employing a refractive index detector and polydimethylsiloxane standards.

The organohydrogenpolysiloxane typically has a viscosity of from 0.01 to 100,000 Pa·s, alternatively from 0.1 to 10,000 Pa·s, alternatively from 0.2 to 20 Pa·s, at 25° C.

Examples of organohydrogenpolysiloxanes having the formula (I) include, but are not limited to, polysiloxanes having the following formulae:
Me₃SiO(MeHSiO_{2/2})_{b}SiMe₃,
Me₃SiO(MeHSiO_{2/2})_{b}(Me₂SiO_{2/2})_{c}SiMe₃, and
[Me₃SiO(MeHSiO_{2/2})_{b}]₃(MeSiO_{3/2}),
   where Me is methyl, and the subscripts b and c, which denote the average numbers of the enclosed units, have values such that the organohydrogenpolysiloxane has a number-average molecular weight of from 500 to 50,000.

Component (A) can be a single organohydrogenpolysiloxane or a mixture comprising two or more different organohydrogenpolysiloxanes, each as described above.

Methods of preparing linear and branched organohydrogenpolysiloxanes, such as hydrolysis and condensation of organohalosilanes or equilibration of cyclosiloxanes, are well known in the art; many of these polysiloxanes are commercially available.

Component (B) is a cross-linking agent selected from (i) at least one organic compound having an average of at least two aliphatic carbon-carbon double bonds per molecule, (ii) at least one organosilane having an average of at least two silicon-bonded alkenyl groups per molecule, (iii) at least one silicone resin having an average of at least two silicon-bonded alkenyl groups per molecule, (iv) at least on organosiloxane having an average of at least two silicon-bonded alkenyl groups per molecule, and (v) a mixture comprising at least two of (i), (ii), (iii), and (iv); wherein the ratio of the number of moles of aliphatic carbon-carbon double bonds in the cross-linking agent (B) to the number of moles of silicon-bonded hydrogen atoms in the organohydrogenpolysiloxane (A) is from 0.005 to 0.7. It is generally understood that cross-linking occurs when the sum of the average number of silicon-bonded hydrogen atoms per molecule in component (A) and the average number of aliphatic carbon-carbon double bonds per molecule in component (B) is greater than four.

Component (B)(i) is at least one organic compound having an average of at least two aliphatic carbon-carbon double bonds per molecule. The organic compound can be any organic compound containing at least two aliphatic carbon-carbon double bonds per molecule, provided the compound does not prevent the organohydrogenpolysiloxane of the silicone composition from curing to form a silicone adhesive, described below, having high char yield, and high adhesion during and after exposure to temperatures above the decomposition temperature of the adhesive. The organic compound can be a diene, a triene, or a polyene. Also, the unsaturated compound can have a linear, branched, or cyclic structure. Further, in acyclic organic compounds, the carbon-carbon double bonds can be located at terminal, pendant, or at both terminal and pendant positions.

The organic compound can contain one or more functional groups other than the aliphatic carbon-carbon double bond. Examples of suitable functional groups include, but are not limited to, —O—, >C═O, —CHO, —CO₂—, —C≡N, —NO₂, >C═C<, —C≡C—, —F, —Cl, —Br, and —I. The suitability of a particular unsaturated organic compound for use in the silicone composition of the present invention can be readily determined by routine experimentation using the methods in the Examples below.

The organic compound typically has a molecular weight less than 500, alternatively less than 400, alternatively less than 300.

The organic compound can have a liquid or solid state at room temperature. Also, the organic compound is typically soluble in the silicone composition. The normal boiling point of the organic compound, which depends on the molecular weight, structure, and number and nature of functional groups in the compound, can vary over a wide range. Preferably, the organic compound has a normal boiling point greater than the cure temperature of the organohydrogenpolysiloxane. Otherwise, appreciable amounts of the organic compound may be removed by volatilization during cure.

Examples of organic compounds containing aliphatic carbon-carbon double bonds include, but are not limited to, 1,4-divinylbenzene, 1,3-hexadienylbenzene, and 1,2-diethenylcyclobutane.

Component (B)(i) can be a single organic compound or a mixture comprising two or more different organic compounds, each as described and exemplified above. Moreover, methods of preparing unsaturated organic compounds are well-known in the art; many of these compounds are commercially available.

Component (B)(ii) is at least one organosilane having an average of at least two silicon-bonded alkenyl groups per molecule. The organosilane can be a monosilane, disilane, trisilane, or polysilane. The structure of the organosilane can be linear, branched, cyclic, or resinous. Cyclosilanes typically have from 3 to 12 silicon atoms, alternatively from 3 to 10 silicon atoms, alternatively from 3 to 5 silicon atoms. In acyclic polysilanes, the alkenyl groups can be located at terminal, pendant, or at both terminal and pendant positions.

Examples of organosilanes suitable for use as component (B)(ii) include, but are not limited to, silanes having the following formulae:
Vi₄Si, PhSiVi₃, MeSiVi₃, PhMeSiVi₂, Ph₂SiVi₂, and PhSi(CH₂CH═CH₂)₃, where Me is methyl, Ph is phenyl, and Vi is vinyl.

Component (B)(ii) can be a single organosilane or a mixture comprising two or more different organosilanes, each as described and exemplified above. Moreover, methods of preparing organosilanes containing alkenyl groups are well-known in the art; many of these compounds are commercially available.

Component (B)(iii) is at least one silicone resin having an average of at least two silicon-bonded alkenyl groups per molecule. For example, the silicone resin may be represented by the formula (R¹R³₂SiO_{1/2})_{w}(R³₂SiO_{2/2})ₓ(R³SiO_{3/2})_{y}(SiO_{4/2})_{z} (II), wherein each R¹ is independently C₁ to C₁₀ hydrocarbyl or C₁ to C₁₀ halogen-substituted hydrocarbyl, both free of aliphatic unsaturation, each R³ is independently R¹ or alkenyl, w is from 0 to 0.95, x is from 0 to 0.95, y is from 0 to 1, z is from 0 to 0.9, y+z is from 0.1 to 1, and w+x+y+z=1, provided the silicone resin has an average of at least two silicon-bonded alkenyl groups per molecule.

The hydrocarbyl groups represented by R¹ are as described and exemplified above for the organohydrogenpolysiloxane of component (A). The alkenyl groups represented by R³, which may be the same or different, typically have from 2 to about 10 carbon atoms, alternatively from 2 to 6 carbon atoms, and are exemplified by, but not limited to, vinyl, allyl, butenyl, hexenyl, and octenyl.

In the formula (I) of the silicone resin, the subscripts w, x, y, and z are mole fractions. The subscript w typically has a value of from 0 to 0.95, alternatively from 0 to 0.8, alternatively from 0 to 0.2; the subscript x typically has a value of from 0 to 0.95, alternatively from 0 to 0.8, alternatively from 0 to 0.5; the subscript y typically has a value of from 0 to 1, alternatively from 0.3 to 1, alternatively from 0.5 to 1; the subscript z typically has a value of from 0 to 0.9, alternatively from 0 to 0.5, alternatively from 0 to 0.1; and the sum y+z typically has value of from 0.1 to 1, alternatively from 0.2 to 1, alternatively from 0.5 to 1, alternatively 0.8 to 1.

Typically at least 50 mol %, alternatively at least 65 mol %, alternatively at least 80 mol % of the groups R³ in the silicone resin are alkenyl. The term “mol % of the groups R³ in the silicone resin are alkenyl” is defined as the ratio of the number of moles of silicon-bonded alkenyl groups in the silicone resin to the total number of moles of the groups R³ in the resin, multiplied by 100.

The silicone resin typically has a weight-average molecular weight (M_{w}) of from 500 to 1,000,000, alternatively from 1,000 to 100,000, alternatively from 1,000 to 50,000, alternatively from 1,000 to 20,000, alternatively form 1,000 to 10,000, where the molecular weight is determined by gel permeation chromatography employing a refractive index detector and polystyrene standards.

The silicone resin typically contains less than 10% (w/w), alternatively less than 5% (w/w), alternatively less than 2% (w/w), of silicon-bonded hydroxy groups, as determined by ²⁹Si NMR.

Examples of silicone resins suitable for use as component (B)(iii) include, but are not limited to, resins having the following formulae:
(Vi₂MeSiO_{1/2})_{0.25}(PhSiO_{3/2})_{0.75}, (ViMe₂SiO_{1/2})_{0.25}(PhSiO_{3/2})_{0.75},
(ViMe₂SiO_{1/2})_{0.25}(MeSiO_{3/2})_{0.25}(PhSiO_{3/2})_{0.50}, (ViMe₂SiO_{1/2})_{0.15}(^{PhSiO}_{3/2})^{0.75} (SiO_{4/2})_{0.1}, and (Vi₂MeSiO_{1/2})_{0.15}(ViMe₂SiO_{1/2})_{0.1}(PhSiO_{3/2})_{0.75}, where Me is methyl, Vi is vinyl, Ph is phenyl, and the numerical subscripts outside the parenthesis denote mole fractions. Also, in the preceding formulae, the sequence of units is unspecified.

Component (B)(iii) can be a single silicone resin or a mixture comprising two or more different silicone resins, each as described above. Also, methods of preparing silicone resins containing silicon-bonded alkenyl groups, such as cohydrolysis of the appropriate mixture of chlorosilane precursors, are well known in the art; many of these resins are commercially available.

Component (B)(iv) is at least one organosiloxane having an average of at least two silicon-bonded alkenyl groups per molecule.

The organosiloxane typically has a number-average molecular weight (Mₙ) of from 186 to 7,500, alternatively from 250 to 3,000, alternatively from 300 to 1,500, where the molecular weight is determined by gel permeation chromatography employing a refractive index detector and polydimethylsiloxane standards.

Examples of organosiloxanes suitable for use as component (B)(iv) include, but are not limited to, organosiloxanes having the following formulae:
(ViMe₂Si)₂O, (Vi₂MeSi)₂O, ((CH₂═CHCH₂)Me₂Si)₂O, (ViMe₂SiO_{1/2})₄Si,
(ViMeSiO_{2/2})₄, (ViMe₂SiO_{1/2})₂SiPh₂, (ViPhMeSi)₂O, ((CH₂═CHC₄H₈)Me₂SiO_{1/2}) 2SiMe₂, and PhSi(OSiMe₂Vi)₃, where Me is methyl, Ph is phenyl, Vi is vinyl.

Component (B)(iv) can be a single organosiloxane or a mixture comprising two or more different organosiloxanes, each as described and exemplified above. Moreover, methods of preparing organosiloxanes containing silicon-bonded alkenyl groups are well-known in the art; many of these compounds are commercially available.

Component (B)(v) is a mixture comprising at least two of (B)(i), (B)(ii), (B)(iii), and (B)(iv), each as described and exemplified above.

The concentration of component (B) is sufficient to cure (cross-link) the organohydrogenpolysiloxane of component (A). The exact amount of component (B) depends on the desired extent of cure, which generally increases as the ratio of the number of moles of aliphatic carbon-carbon double bonds in component (B) to the number of moles of silicon-bonded hydrogen atoms in component (A) increases. The concentration of component (B) is typically sufficient to provide not greater than 0.7 moles of aliphatic carbon-carbon double bonds, alternatively not greater than 0.5 moles of aliphatic carbon-carbon double bonds, alternatively not greater than 0.3 moles of aliphatic carbon-carbon double bonds, per mole of silicon-bonded hydrogen atoms in component (A). For example, the concentration of component (B) is typically sufficient to provide from 0.005 to 0.7 moles of aliphatic carbon-carbon double bonds, alternatively from 0.03 to 0.3 moles of aliphatic carbon-carbon double bonds, alternatively from 0.05 to 0.2 moles of aliphatic carbon-carbon double bonds, per mole of silicon-bonded hydrogen atoms in component (A).

Component (C) of the hydrosilylation-curable silicone composition is at least one hydrosilylation catalyst that promotes the addition reaction of component (A) with component (B). The hydrosilylation catalyst can be any of the well-known hydrosilylation catalysts comprising a platinum group metal, a compound containing a platinum group metal, or a microencapsulated platinum group metal-containing catalyst. Platinum group metals include platinum, rhodium, ruthenium, palladium, osmium and iridium. Preferably, the platinum group metal is platinum, based on its high activity in hydrosilylation reactions.

Preferred hydrosilylation catalysts include the complexes of chloroplatinic acid and certain vinyl-containing organosiloxanes disclosed by Willing in U.S. Pat. No. 3,419,593, which is hereby incorporated by reference. A preferred catalyst of this type is the reaction product of chloroplatinic acid and 1,3-diethenyl-1,1,3,3-tetramethyldisiloxane.

The hydrosilylation catalyst can also be a microencapsulated platinum group metal-containing catalyst comprising a platinum group metal encapsulated in a thermoplastic resin. Compositions containing microencapsulated hydrosilylation catalysts are stable for extended periods of time, typically several months or longer, under ambient conditions, yet cure relatively rapidly at temperatures above the melting or softening point of the thermoplastic resin(s). Microencapsulated hydrosilylation catalysts and methods of preparing them are well known in the art, as exemplified in U.S. Pat. No. 4,766,176 and the references cited therein; and U.S. Pat. No. 5,017,654.

Component (C) can be a single hydrosilylation catalyst or a mixture comprising two or more different catalysts that differ in at least one property, such as structure, form, platinum group metal, complexing ligand, and thermoplastic resin.

The concentration of component (C) is sufficient to catalyze the addition reaction of component (A) with component (B). Typically, the concentration of component (C) is sufficient to provide from 0.1 to 1000 ppm of a platinum group metal, preferably from 0.5 to 500 ppm of a platinum group metal, and more preferably from 1 to 20 ppm of a platinum group metal, based on the combined weight of components (A) and (B). The rate of cure is very slow below 0.1 ppm of platinum group metal. The use of more than 1000 ppm of platinum group metal results in no appreciable increase in cure rate, and is therefore uneconomical.

The silicone composition can comprise additional ingredients, provided the ingredient does not prevent the organohydrogenpolysiloxane from curing to form a silicone adhesive, described below, having high char yield, and high adhesion during and after exposure to temperatures above the decomposition temperature of the adhesive. Examples of additional ingredients include, but are not limited to, hydrosilylation catalyst inhibitors, such as 3-methyl-3-penten-1-yne, 3,5-dimethyl-3-hexen-1-yne, 3,5-dimethyl-1-hexyn-3-ol, 1-ethynyl-1-cyclohexanol, 2-phenyl-3-butyn-2-ol, vinylcyclosiloxanes, and triphenylphosphine; adhesion promoters, such as the adhesion promoters taught in U.S. Pat. Nos. 4,087,585 and 5,194,649; dyes; pigments; anti-oxidants; heat stabilizers; UV stabilizers; flame retardants; flow control additives; fillers, such as reinforcing fillers and extending fillers; and diluents, such as organic solvents and reactive diluents.

The silicone composition typically does not contain an organic solvent. However, the composition may further comprise an organic solvent to reduce viscosity of the composition or facilitate application of the composition on a substrate.

In one embodiment, the silicone composition further comprises a reactive diluent. For example, the silicone composition can further comprise a reactive diluent comprising an organosiloxane having an average of at least two silicon-bonded alkenyl groups per molecule and a viscosity of from 0.001 to 2 Pa·s at 25° C., wherein the viscosity of the organosiloxane is not greater than 20% of the viscosity of the organohydrogenpolysiloxane, component (A) above, of the silicone composition and the organosiloxane has the formula (R¹R⁴₂SiO_{1/2})_{c} (R⁴₂SiO_{2/2})_{d}(R¹SiO_{3/2})ₑ(SiO_{4/2})_{f}, wherein R¹ is C₁ to C₁₀ hydrocarbyl or C₁ to C₁₀ halogen-substituted hydrocarbyl, both free of aliphatic unsaturation, R⁴ is R¹ or alkenyl, c is 0 to 0.8, d=0 to 1, e=0 to 0.25, f=0 to 0.2, c+d+e+f=1, and c+d is not equal to 0, provided when e+f=0, d is not equal to 0 and the alkenyl groups are not all terminal. Further, the organosiloxane can have a linear, branched, or cyclic structure.

The viscosity of the organosiloxane at 25° C. is typically from 0.001 to 2 Pa·s, alternatively from 0.001 to 0.1 Pa·s, alternatively from 0.001 to 0.05 Pa·s. Further, the viscosity of the organosiloxane at 25° C. is typically not greater than 20%, alternatively not greater than 10%, alternatively not greater than 1%, of the viscosity of the organohydrogenpolysiloxane in the silicone composition.

Examples of organosiloxanes suitable for use as reactive diluents include, but are not limited to, organosiloxanes having the following formulae:
(ViMeSiO)₃, (ViMeSiO)₄, (ViMeSiO)₅, (ViMeSiO)₆, (ViPhSiO)₃, (ViPhSiO)₄,
(ViPhMeSi)₂O, (ViMe₂Si)₂O, (ViPhSiO)₅, (ViPhSiO)₆, ViMe₂SiO(ViMeSiO)ₙSiMe₂Vi, Me₃SiO(ViMeSiO)ₙSiMe₃, and (ViMe₂SiO)₄Si, where Me is methyl, Ph is phenyl, Vi is vinyl, and the subscript n has a value such that the organosiloxane has a viscosity of from 0.001 to 2 Pa·s at 25° C.

The reactive diluent can be a single organosiloxane or a mixture comprising two or more different organosiloxanes, each as described above. Methods of making alkenyl-functional organosiloxanes are well known in the art.

The concentration of the reactive diluent in the silicone composition is typically from 1 to 20% (w/w), alternatively from 1 to 10% (w/w), alternatively from 1 to 5% (w/w), based on the combined weight of the organohydrogenpolysiloxane, component (A), and the cross-linking agent, component (B).

Also, the concentration of the reactive diluent in the silicone composition is such that the ratio of the sum of the number of moles of aliphatic carbon-carbon double bonds in the cross-linking agent, component (B), and the reactive diluent to the number of moles of silicon-bonded hydrogen atoms in the organohydrogenpolysiloxane, component (A), is typically from 0.005 to 0.7, alternatively from 0.03 to 0.3, alternatively from 0.05 to 0.2.

In one embodiment, the silicone composition further comprises at least one ceramic filler. Examples of ceramic fillers include, but are not limited to, nitrides such as silicon nitride, boron nitride, aluminum nitride, titanium nitride, and zirconium nitride; carbides such as silicon carbide, boron carbide, tungsten carbide, titanium carbide, zirconium carbide, and molybdenum carbide; metal oxides, such as the oxides of aluminum, magnesium, zinc, beryllium, zirconium, titanium and thorium; silicates, such as the silicates of aluminum, magnesium, zirconium, and titanium; and complex silicates, such as magnesium aluminum silicate.

The silicone composition is typically prepared by combining the principal components and any optional ingredients in the stated proportions at ambient temperature, with or without the aid of an organic solvent. Although the order of addition of the various components is not critical if the silicone composition is to be used immediately, the hydrosilylation catalyst is preferably added last at a temperature below about 30° C. to prevent premature curing of the composition.

Mixing can be accomplished by any of the techniques known in the art such as milling, blending, and stifling, either in a batch or continuous process. The particular device is determined by the viscosity of the components and the viscosity of the final silicone composition.

A silicone adhesive according to the present invention comprises a cured product of at least one organohydrogenpolysiloxane having the formula (I) above, where the organohydgenpolysiloxane is as described and exemplified above for the silicone composition.

As used herein, the term “cured product of at least one organohydrogenpolysiloxane” refers to a cross-linked polysiloxane resin having a three-dimensional network structure.

The silicone adhesive typically has high transparency. The transparency of the adhesive depends on a number of factors, such as the composition and thickness of the adhesive. For example, a silicone adhesive film having a thickness of 50 μm typically has a % transmittance of at least 80%, alternatively at least 90%, for light in the visible region (˜400 to ˜700 nm) of the electromagnetic spectrum.

The silicone adhesive can be prepared by curing the organohydrogenpolysiloxane of the silicone composition described above. The organohydrogenpolysiloxane can be cured by exposing the silicone composition to a temperature of from room temperature (˜23±2° C.) to 250° C., alternatively from room temperature to 200° C., alternatively from room temperature to 150° C., at atmospheric pressure. The silicone composition is generally heated for a length of time sufficient to cure (cross-link) the organohydrogenpolysiloxane. For example, the composition is typically heated at a temperature of from 150 to 200° C. for a time of from 0.1 to 3 h.

The present invention is further directed to a coated substrate, comprising:
a substrate; and
a silicone adhesive coating on at least a portion of a surface of the substrate, wherein the adhesive coating comprises a cured product of at least one organohydrogenpolysiloxane having the formula (I) above.

The substrate can be any rigid or flexible material having a planar, complex, or irregular contour. The substrate can be transparent or nontransparent to light in the visible region (˜400 to ˜700 nm) of the electromagnetic spectrum. Also, the substrate can be an electrical conductor, semiconductor, or nonconductor. Examples of substrates include, but are not limited to, semiconductors such as silicon, silicon having a surface layer of silicon dioxide, silicon carbide, indium phosphide, and gallium arsenide; quartz; fused quartz; aluminum oxide; ceramics; glass such as soda-lime glass, borosilicate glass, lead-alkali glass, borate glass, silica glass, alumino-silicate glass, lead-borate glass, sodium borosilicate glass, lithium aluminosilicate glass, Chalcogenide glass, phosphate glass, and alkali-barium silicate glass; metal foils; polyolefins such as polyethylene, polypropylene, polystyrene, polyethylene terephthalate (PET), and polyethylene naphthalate; fluorocarbon polymers such as polytetrafluoroethylene and polyvinylfluoride; polyamides such as Nylon; polyimides; polyesters such as poly(methyl methacrylate); epoxy resins; polyethers; polycarbonates; polysulfones; and polyether sulfones.

In addition, the substrate can be a reinforced silicone resin film prepared by impregnating a fiber reinforcement (e.g., woven or nonwoven glass fabric, or loose glass fibers) in a curable silicone composition comprising a silicone resin, and heating the impregnated fiber reinforcement to cure the silicone resin. Reinforced silicone resin films prepared from various types of curable silicone compositions are known in the art, as exemplified in the following International Patent Application Publications: WO2006/088645, WO2006088646, WO2007/092032, and WO2007/018756.

The coated substrate comprises a silicone adhesive coating on at least a portion of a surface of the substrate. The silicone adhesive coating may be on a portion of one or more surfaces of the substrate or on all of one or more surfaces. For example, when the substrate is a flat panel, the silicone adhesive coating may be on one side, on both sides, or on both sides and the edges, of the substrate.

The silicone adhesive coating comprises a cured product of at least one organohydrogenpolysiloxane having the formula (I), wherein the cured product is as described and exemplified above for the silicone adhesive of the present invention.

The silicone adhesive coating can be a single layer coating comprising one layer of a silicone adhesive, or a multiple layer coating comprising two or more layers of at least two different silicone adhesives, where directly adjacent layers comprise different silicone adhesives (i.e., cured products have a different composition and/or property). The multiple layer coating typically comprises from 2 to 7 layers, alternatively from 2 to 5 layers, alternatively from 2 to 3 layers.

The single layer silicone adhesive coating typically has a thickness of from 0.03 to 300 μm, alternatively from 0.1 to 100 μm, alternatively from 0.1 to 50 μm. The multiple layer coating typically has a thickness of from 0.06 to 300 μm, alternatively from 0.2 to 100 μm, alternatively 0.2 to 50 μm. When the thickness of the silicone adhesive coating is less than 0.03 μm, the coating may become discontinuous. When the thickness of the silicone adhesive coating is greater than 300 μm, the coating may exhibit reduced adhesion and/or cracking.

The coated substrate can be prepared by forming a silicone adhesive coating on a substrate, where the adhesive coating and the substrate are as defined and exemplified above. For example, a coated substrate comprising a single-layer silicone adhesive coating can be prepared by (i) applying a silicone composition, described above, on a substrate to form a film, and (ii) curing the organohydrogenpolysiloxane of the film. The silicone composition can be applied on the substrate using conventional methods such as spin coating, dip coating, spray coating, flow coating, screen printing, and roll coating. When present, the solvent is typically allowed to evaporate from the coated substrate before the film is heated. Any suitable means for evaporation may be used such as simple air drying, applying a vacuum, or heating (up to 50° C.).

The organohydrogenpolysiloxane of the film can be cured under the conditions described above in the method of preparing the silicone adhesive of the present invention.

The method of preparing the coated substrate, wherein the coating comprises a single layer adhesive coating can further comprise repeating the steps (i) and (ii) to increase the thickness of the coating, except the silicone composition is applied on the cured adhesive film rather than the substrate, and the same silicone composition is used for each application.

A coated substrate comprising a multiple layer silicone adhesive coating can be prepared in a manner similar to the method used to prepare a single layer coating, only adjacent layers of the coating are prepared using a silicone composition having a different composition and typically each film is at least partially cured before applying the silicone composition of the next layer. For example, a coated substrate comprising a silicone adhesive coating having two layers can be prepared by (i) applying a silicone composition, described above, on a substrate to form a first film, (ii) at least partially curing the organohydrogenpolysiloxane of the first film, (iii) applying a silicone composition different from the composition in (i), on the partially cured first film to form a second film, and (iv) curing the organohydrogenpolysiloxane of the second film.

A laminated substrate according to the present invention comprises
a first substrate;
at least one additional substrate overlying the first substrate; and
a silicone adhesive coating on at least a portion of at least one surface of each substrate, provided at least a portion of the adhesive coating is between and in direct contact with opposing surfaces of adjacent substrates, wherein the adhesive coating comprises a cured product of at least one organohydrogenpolysiloxane having the formula (I) above.

As used herein, the term “overlying” used in reference to the additional substrates means each additional substrate occupies a position over, but not in direct contact with, the first substrate and any intervening substrate(s).

The substrates and the silicone adhesive coating of the laminated substrate are as described and exemplified above for the coated substrate of the present invention. The laminated substrate comprises a first substrate and at least one additional substrate. The laminated substrate typically contains from 1 to 20 additional substrates, alternatively from 1 to 10 additional substrates, alternatively from 1 to 4 additional substrates. When the laminated substrate is a laminated glass substrate, at least one of the substrates is glass and, optionally, at least one of the substrates is a reinforced silicone resin film, described above.

The laminated substrate comprises a silicone adhesive coating on at least a portion of at least one surface of each substrate. The adhesive coating may be on a portion of one or more surfaces of each substrate or on all of one or more surfaces of each substrate. For example, when the laminated substrate is a laminated glass comprising glass panes, the silicone adhesive coating may be on one side, on both sides, or on both sides and the edges, of each pane.

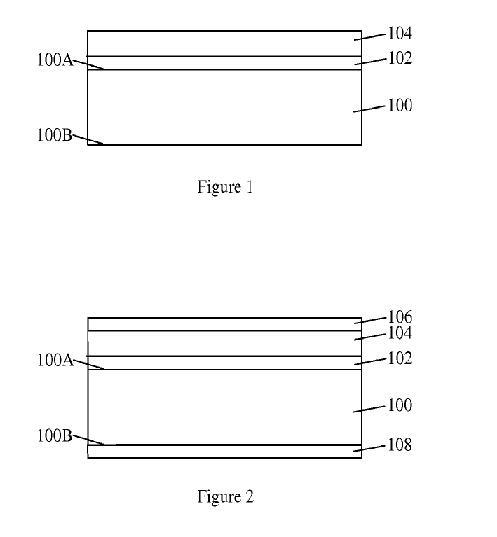

As shown in FIG. 1, one embodiment of a laminated substrate according to the present invention comprises a first substrate 100 having a first opposing surface 100A and a second opposing surface 100B; a first silicone adhesive coating 102 on the first opposing surface 100A of the first substrate 100, wherein the first silicone adhesive coating 102 comprises a cured product of at least one organohydrogenpolysiloxane having the formula (I) above; and a second substrate 104 on the first silicone adhesive coating 102.

As shown in FIG. 2, the preceding embodiment of the laminated substrate can further comprise a second silicone adhesive coating 106 on the second substrate 104 and a third silicone adhesive coating 108 on the second opposing surface 100B of the first substrate 100, wherein the second and third adhesive coatings each comprise a cured product of at least one organohydrogenpolysiloxane having the formula (I) above.

A suitable method of preparing the laminated substrate is illustrated here for the laminated substrate depicted in FIG. 1. The laminated substrate can be prepared by (i) applying a silicone composition, described above, on a first surface of a substrate to form a first adhesive film; (ii) applying a second substrate on the first adhesive film; and (iii) curing the organohydrogenpolysiloxane of the first adhesive film. Laminated substrates comprising additional silicone adhesive coatings and substrates can be prepared in a similar manner. When the laminated substrate comprises at least one multiple layer silicone adhesive coating, typically each layer of the coating is at least partially cured before the next layer is formed.

The silicone adhesive of the present invention has high transparency and excellent adhesion to various substrates. Moreover, the silicone adhesive has high adhesion during and after exposure to temperatures above the decomposition temperature of the adhesive, low flammability (as evidenced by low heat release rate), and high char yield.

The silicone adhesive of the present invention is useful in applications requiring adhesives having high adhesion at elevated temperatures, low flammability, and high transparency. For example, the adhesive is useful for bonding glass panels in the fabrication of fire rated windows and glass firewalls.

### EXAMPLES

The following examples are presented to better illustrate the silicone composition and laminated substrate of the present invention, but are not to be considered as limiting the invention, which is delineated in the appended claims. Unless otherwise noted, all parts and percentages reported in the examples are by weight. The following materials were employed in the examples:

Organohydrogenpolysiloxane A is a poly(dimethyl/hydrogenmethyl)siloxane having the formula Me₃SiO(Me₂SiO)_{3.2}(HMeSiO)_{5.8}SiMe₃, where Me is methyl and the subscripts outside the parentheses denote the average numbers of the enclosed units.

Organohydrogenpolysiloxane B is a poly(dimethyl/hydrogenmethyl)siloxane having the formula Me₃SiO(Me₂SiO)_{8.7}(HMeSiO)_{3.7}SiMe₃, where Me is methyl and the subscripts outside the parentheses denote the average numbers of the enclosed units.

Organohydrogenpolysiloxane C is a poly(hydrogenmethyl)siloxane having the formula Me₃SiO(HMeSiO)₆₅SiMe₃, where Me is methyl and the subscript outside the parenthesis denotes the average number of the enclosed unit.

Organohydrogenpolysiloxane D is a poly(dimethyl/hydrogenmethyl)siloxane having the formula Me₃SiO(Me₂SiO)_{16.2}(HMeSiO)₃₉SiMe₃, where Me is methyl and the subscripts outside the parentheses denote the average numbers of the enclosed units.

Organohydrogenpolysiloxane E is an M^{H}Q resin having the formula (HMe₂SiO_{1/2})_{1.84} (SiO_{4/2}), where Me is methyl and the subscripts outside the parentheses (subscript 1 not shown) denote the relative numbers of moles of the enclosed units.

Cross-linking Agent A is 1,3,5-7-tetramethyl-1,3,5,7-tetravinylcyclotetrasiloxane.

Cross-linking Agent B is an organosiloxane having the formula HO(ViMeSiO)₉H, where Me is methyl, Vi is vinyl, and the subscript outside the parenthesis denotes the average number of the enclosed unit.

Cross-linking Agent C is an organosiloxane having the formula (ViMePhSi)₂O, where Me is methyl, Ph is phenyl, and Vi is vinyl.

Cross-linking Agent D is an organosiloxane having the formula (PhSiO_{3/2})_{0.2}(Me₂SiO)_{0.6}(Me₂ViSiO_{1/2})_{0.2,} where Me is methyl, Vi is vinyl, and the subscripts outside the parentheses denote mole fractions.

Cross-linking Agent E is an organopolysiloxane having the formula ViMe₂SiO(Me₂SiO)₁₄₈SiMe₂Vi, where Me is methyl, Vi is vinyl, and the subscript outside the parenthesis denotes the average number of the enclosed unit.

Cross-linking Agent F is a solution containing 60% (w/w) of an organopolysiloxane having the formula (Me₃SiO_{1/2})_{0.4}(ViMe₂SiO_{1/2})_{0.05}(SiO_{4/2})_{0.55} in xylene.

Platinum Catalyst is a mixture containing a platinum(0) complex of 1,3-divinyl-1,1,3,3,-tetramethyldisiloxane in toluene, and having a platinum concentration of 1000 ppm.

Silicone Base: a mixture containing 82% of a silicone resin having the formula (PhSiO_{3/2})_{0.75}(ViMe₂SiO_{1/2})_{0.25}, where the resin has a weight-average molecular weight of about 1700, a number-average molecular weight of about 1440, and contains about 1 mol % of silicon-bonded hydroxy groups; and 18% of 1,4-bis(dimethylsilyl)benzene. The mole ratio of silicon-bonded hydrogen atoms in the 1,4-bis(dimethylsilyl)benzene to silicon-bonded vinyl groups in the silicone resin is 1.1:1, as determined by ²⁹SiNMR and ¹³CNMR.

Melinex® 516, sold by Dupont Teijin Films (Hopewell, Va.), is a polyethylene-terephthalate (PET) film pretreated on one side with a release agent for slip and having a thickness of 125 μm.

Glass Fabric is a heat-treated glass fabric prepared by heating style 106 electrical glass fabric having a plain weave and a thickness of 37.5 μm at 575° C. for 6 h. The untreated glass fabric was obtained from JPS Glass (Slater, S.C.).

### Example 1

Silicone Base was mixed with 0.5% (w/w), based on the weight of the Base, of Platinum Catalyst. The resulting composition was applied on the release agent-treated surface of a Melinex® 516 PET film (8 in.×11 in.) to form a silicone film. Glass Fabric having the same dimensions as the PET film was carefully laid down on the silicone film, allowing sufficient time for the composition to thoroughly wet the fabric. The aforementioned silicone composition was then uniformly applied to the embedded fabric. An identical PET film was placed on top of the coating with the release agent-treated side in contact with the silicone composition. The stack was then passed between two stainless steel bars separated by a distance of 300 μm. The laminate was heated in an oven according at 150° C. for 10 min. The oven was turned off and the laminate was allowed to cool to room temperature inside the oven. The upper PET film was separated (peeled away) from the reinforced silicone resin film, and the silicone resin film was then separated from the lower PET film. The transparent reinforced silicone resin film had a thickness of about 125 μm.

### Examples 2-10

In each of Examples 2-10 a silicone composition was prepared by combining Organohydrogenpolysiloxane, Cross-linking Agent, and Platinum Catalyst in the amounts specified in Table 1.

Samples of each silicone composition (˜2 g) were placed in individual stainless steel pans, heated in an oven at 150° C. for 2 h to cure the organohydrogenpolysiloxane, and then allowed to cool to room temperature. The adhesive samples were heated in air at 800° C. for 30 min. to produce a char and then allowed to cool to room temperature. The char yield of each adhesive was calculated by dividing the mass of the adhesive after char by the mass of the (cured) adhesive before char and multiplying the quotient by 100. The char yield of each adhesive is reported in Table 2.

Laminated glass composites were prepared using each of the silicone compositions according to the following procedure: Two flat float glass plates (6 in.×6 in.×⅛ in.) were washed with a warm solution of detergent in water, thoroughly rinsed with deionized water, and dried in air. Approximately 2 g of the silicone composition was applied on one side of each glass plate. The reinforced silicone resin film of Example 1 having the same dimensions as the glass plates was placed on the coated surface of one of the glass plates, and the coated surface of the other glass plate was then placed on the exposed surface of the reinforced silicone resin film. The laminate was held under vacuum (2500 Pa) at room temperature for 2 h. The composite was heated in an oven at a rate of 3° C./min. to 150° C., at which temperature the laminate was maintained for 2 h. The oven was turned off and the laminated glass was allowed to cool to room temperature inside the oven.

A torch supplied with propylene at a pressure of 10 psi (6.9×10⁴ Pa) and having an orifice diameter of 2.5 in. perpendicular to one flat surface of the laminated glass at a distance of 11 in. from the surface. The laminated glass was exposed to the torch for 10 min. and then allowed to cool to room temperature. After heat treatment, the glass plates in the laminate remained bonded to the reinforced silicone resin film.

### Comparative Examples 1-3

In each of Comparative Examples 1-3 a silicone composition was prepared using the components and amounts specified in Table 1. In Comparative Examples 1 and 2, the Organohydrogenpolysiloxane, Cross-linking Agent, and Platinum Catalyst were combined in order. In Comparative Example 3, Organohydrogenpolysiloxane E and Cross-linking Agent F were combined first, and then xylene was removed under reduced pressure at 100° C. This mixture was then combined with Cross-linking Agent A and Platinum Catalyst.

Samples of each composition were heated to produce adhesives using the method described above in Examples 2-10. The char yield of each adhesive is reported in Table 2.

Furthermore, laminated glass composites were prepared using each of the silicone compositions and then heat-treated, both according to the method of Examples 2-10. During heat treatment, the glass plates in the laminate separated from the reinforced silicone resin film.

TABLE 1

| | Parts by Weight | | | | | | | | | | | |
|---|---|---|---|---|---|---|---|---|---|---|---|---|
| | Example | | | | | | | | | | | |
| Component | 2 | 3 | 4 | 5 | 6 | 7 | 8 | 9 | 10 | C-1 | C-2 | C-3 |
| Organohydrogen- | | | | | | | | | | | | |
| polysiloxane | | | | | | | | | | | | |
| A | 98.3 | 94.7 | 87.1 | 83.8 | — | — | — | — | — | 2.0 | 5.4 | — |
| B | — | — | — | — | 90.7 | — | — | — | — | — | — | — |
| C | — | — | — | — | — | 68.6 | — | 73.8 | 55.9 | — | — | — |
| D | — | — | — | — | — | — | 88.5 | — | — | — | — | — |
| E | — | — | — | — | — | — | — | — | — | — | — | 27.8 |
| Cross-linking | | | | | | | | | | | | |
| Agent | | | | | | | | | | | | |
| A | 1.7 | 5.3 | 12.9 | — | 9.3 | 31.4 | 11.5 | — | — | — | — | 16.0 |
| B | — | — | — | 16.2 | — | — | — | — | — | — | — | — |
| C | — | — | — | — | — | — | — | 26.2 | — | — | — | — |
| D | — | — | — | — | — | — | — | — | 44.1 | — | — | — |
| E | — | — | — | — | — | — | — | — | — | 98.0 | 94.6 | — |
| F | — | — | — | — | — | — | — | — | — | — | — | 56.2 |
| Platinum Catalyst | 0.5 | 0.5 | 0.5 | 0.5 | 0.5 | 0.1 | 0.5 | 2 | 1.6 | 0.1 | 0.1 | 0.1 |

C-1, C-2, and C-3 denote Comparative Examples 1, 2, and 3, respectively.

TABLE 2

| Example | Char Yield % |
|---|---|
| 2 | 67.4 |
| 3 | 71.5 |
| 4 | 81.2 |
| 5 | 73.5 |
| 6 | 66.8 |
| 7 | 89.8 |
| 8 | 80.3 |
| 9 | 83.8 |
| 10 | Not tested |
| C-1 | 5.15 |
| C-2 | 60.9 |
| C-3 | 79.4 |

That which is claimed is:

1. A silicone composition, comprising:
(A) at least one organohydrogenpolysiloxane having the formula (R¹₂R²SiO_{1/2})ₘ (R¹R²SiO_{2/2})ₙ(R¹SiO_{3/2})ₚ (I), wherein each R¹ is independently C₁ to C₁₀ hydrocarbyl or C₁ to C₁₀ halogen-substituted hydrocarbyl, both free of aliphatic unsaturation, each R² is independently R¹ or —H, m is from 0.001 to 0.3, n is from 0.5 to 0.999, p is from 0 to 0.5, and m+n+p=1, provided the organohydrogenpolysiloxane has an average of at least two silicon-bonded hydrogen atoms per molecule;
(B) a cross-linking agent selected from (i) at least one organic compound having an average of at least two aliphatic carbon-carbon double bonds per molecule, (ii) at least one organosilane having an average of at least two silicon-bonded alkenyl groups per molecule, (iii) at least one silicone resin having an average of at least two silicon-bonded alkenyl groups per molecule, (iv) at least on organosiloxane having an average of at least two silicon-bonded alkenyl groups per molecule, and (v) a mixture comprising at least two of (i), (ii), (iii), and (iv); wherein the ratio of the number of moles of aliphatic carbon-carbon double bonds in the cross-linking agent (B) to the number of moles of silicon-bonded hydrogen atoms in the organohydrogenpolysiloxane (A) is from 0.005 to 0.7; and
(C) a hydrosilylation catalyst.

2. The silicone composition according to claim 1, wherein the subscript n has a value of from 0.6 to 0.9.

3. The silicone composition according to claim 1, wherein the subscript p has a value of from 0 to 0.3.

4. A silicone adhesive comprising a cured product of at least one organohydrogenpolysiloxane having the formula (R¹₂R²SiO_{1/2})ₘ(R¹R²SiO_{2/2})ₙ(R¹SiO_{3/2})ₚ (I), wherein each R¹ is independently C₁ to C₁₀ hydrocarbyl or C₁ to C₁₀ halogen-substituted hydrocarbyl, both free of aliphatic unsaturation, each R² is independently R¹ or —H, m is from 0.001 to 0.3, n is from 0.5 to 0.999, p is from 0 to 0.5, and m+n+p=1, provided the organohydrogenpolysiloxane has an average of at least two silicon-bonded hydrogen atoms per molecule.

5. The silicone adhesive according to claim 4, wherein the subscript n has a value of from 0.6 to 0.9.

6. The silicone adhesive according to claim 4, wherein the subscript p has a value of from 0 to 0.3.

7. A coated substrate, comprising:
a substrate; and
a silicone adhesive coating on at least a portion of a surface of the substrate, wherein the adhesive coating comprises a cured product of at least one organohydrogenpolysiloxane having the formula
(R¹₂R²SiO_{1/2})ₘ(R¹R²SiO_{2/2})ₙ(R¹SiO_{3/2})ₚ (I), wherein each R¹ is independently C₁ to C₁₀ hydrocarbyl or C₁ to C₁₀ halogen-substituted hydrocarbyl, both free of aliphatic unsaturation, each R² is independently R¹ or —H, m is from 0.001 to 0.3, n is from 0.5 to 0.999, p is from 0 to 0.5, and m+n+p=1, provided the organohydrogen-polysiloxane has an average of at least two silicon-bonded hydrogen atoms per molecule.

8. The coated substrate according to claim 7, wherein the subscript n has a value of from 0.6 to 0.9.

9. The coated substrate according to claim 7, wherein the subscript p has a value of from 0 to 0.3.

10. The coated substrate according to claim 7, wherein the substrate is selected from glass and a reinforced silicone resin film.

11. A laminated substrate, comprising:
a first substrate;
at least one additional substrate overlying the first substrate; and
a silicone adhesive coating on at least a portion of at least one surface of each substrate, provided at least a portion of the adhesive coating is between and in direct contact with opposing surfaces of adjacent substrates, wherein the adhesive coating comprises a cured product of at least one organohydrogenpolysiloxane having the formula (R¹₂R²SiO_{1/2})ₘ (R¹R²SiO_{2/2})ₙ(R¹SiO_{3/2})ₚ (I), wherein each R¹ is independently C₁ to C₁₀ hydrocarbyl or C₁ to C₁₀ halogen-substituted hydrocarbyl, both free of aliphatic unsaturation, each R² is independently R¹ or —H, m is from 0.001 to 0.3, n is from 0.5 to 0.999, p is from 0 to 0.5, and m+n+p=1, provided the organohydrogenpolysiloxane has an average of at least two silicon-bonded hydrogen atoms per molecule.

12. The laminated substrate according to claim 11, wherein the subscript n has a value of from 0.6 to 0.9.

13. The laminated substrate according to claim 11, wherein the subscript p has a value of from 0 to 0.3.

14. The laminated substrate according to claim 11, wherein at least one of the substrates is glass.

15. The laminated substrate according to claim 11, wherein at least one of the substrates is a reinforced silicone resin film.
